(19) United States
(12) Patent Application Publication
(10) Pub. No.: US 2006/0193608 A1
(43) Pub. Date: Aug. 31, 2006

(54) Method and apparatus for reproducing data from recording medium using local storage

(76) Inventor: Kun Suk Kim, Anyang-si (KR)

Correspondence Address: HARNESS, DICKEY & PIERCE, P.L.C., P.O. BOX 8910, RESTON, VA, 20195, US

(21) Appl. No.: 11/342,609

(22) Filed: Jan. 31, 2006

Related U.S. Application Data
(60) Provisional application No. 60/655,909, filed on Feb. 25, 2005.

(30) Foreign Application Priority Data
Oct. 26, 2005 (KR) 10-2005-0101232

(51) Int. Cl. H04N 5/00; G06F 7/00

(52) U.S. Cl. 386/126; 707/100

(57) ABSTRACT

A method and apparatus for reproducing data from a recording medium using a local storage is disclosed. A method for reproducing data from a recording medium using a local storage includes the steps of: a) downloading data associated with the recording medium according to a window size in the local storage, and starting playback or data reproduction by a PlayList which is capable of being played while the data is downloaded; and b) pausing the data reproduction when a reproduction position or a playback position reaches a missing data point, and establishing a new window size larger than the window size. Therefore, the method can effectively reproduce additional data, which is downloaded in the local storage in association with the recording medium, resulting in the creation of more convenient functions for a user.

This application claims the benefit of Korean Patent Application No. 10-2005-0101232, filed on, Oct. 26, 2005, which is hereby incorporated by reference as if fully set forth herein.

This application claims the benefit of the U.S. Provisional Application No. 60/655,909, filed on Feb. 25, 2005, in the name of inventor Kun Suk KIM, entitled “DELAY HANDLING METHOD IN PROGRESSIVE PLAYBACK OF BLU-RAY DISC”, which is hereby incorporated by reference as if fully set forth herein.

### BACKGROUND OF THE INVENTION

1. Field of the Invention

The present invention relates to a method and apparatus for reproducing data from a recording medium, and more particularly to a method and apparatus for reproducing data from a recording medium using a local storage contained in an optical recording/reproducing device.

2. Discussion of the Related Art

Generally, there has been widely used an optical disc acting as a recording medium capable of recording a large amount of data therein. Particularly, there has recently been developed a high-density optical recording medium capable of recording/storing high-quality video data and high-quality audio data for a long period of time, for example, a Blu-ray Disc (BD).

The BD based on the next-generation recording medium technique has been considered to be the next-generation optical recording solution capable of storing much more data than a conventional DVD. In recent times, many developers have conducted intensive research into the international standard technical specification associated with the BD along with those of other digital devices.

In association with the above-mentioned situation, there has recently been developed an optical recording/reproducing device based on the BD international standard, but the BD international standard has not yet been completed, such that many limitations and problems occur in developing the optical recording/reproducing device.

Particularly, the above-mentioned optical recording/reproducing device must consider not only a basic function for recording/reproducing data of the BD, but also an additional function for enabling the optical recording/reproducing device to interact with peripheral digital devices. In other words, the optical recording/reproducing device must receive an external input signal, must display the received signal, and must reproduce desired data using the external input signal and the BD.

However, an apparatus for reproducing data from the recording medium to simultaneously reproduce the external input signal and data of the BD has not yet been established, such that many limitations and problems occur in developing a BD-based optical recording/reproducing device.

### SUMMARY OF THE INVENTION

Accordingly, the present invention is directed to a method and apparatus for reproducing data from a recording medium using a local storage that substantially obviate one or more problems due to limitations and disadvantages of the related art.

An object of the present invention is to provide a method and apparatus for downloading data associated with a recording medium from an external source, storing the downloaded data in a local storage, and reproducing the downloaded data using the recording medium associated with the local storage.

Additional advantages, objects, and features of the invention will be set forth in part in the description which follows and in part will become apparent to those having ordinary skill in the art upon examination of the following or may be learned from practice of the invention. The objectives and other advantages of the invention may be realized and attained by the structure particularly pointed out in the written description and claims hereof as well as the appended drawings.

To achieve these objects and other advantages and in accordance with the purpose of the invention, as embodied and broadly described herein, a method for reproducing data from a recording medium using a local storage comprises the steps of:

a) downloading data associated with the recording medium according to a window size in the local storage, and starting data reproduction by a PlayList which is capable of being played while the data is downloaded, and b) pausing the data reproduction when a reproduction position reaches a missing data point, and establishing a new window size larger than the window size.

The method can further comprise the step of c) downloading data according to the new window size, and resuming the data reproduction. The step of c) can be performed by BD-J application.

The new window size can be established whenever the reproduction position reaches the missing data point.

The new window size (Hᵢ) can be acquired by weighting a previous window size (Hᵢ₋₁) with a predetermined weighted value. The weighted value can be newly determined whenever the reproduction position reaches the missing data point.

The new window size (Hᵢ) can be acquired by adding a previous window size (Hᵢ₋₁) to a value obtained by multiplying a weight constant (α) and a weight function β(Hᵢ₋₁).

The new window size (Hᵢ) can be acquired by multiplying a weight constant (α) and a weight function β(Hᵢ₋₁) associated with a previous window size (Hᵢ₋₁).

The new window size can be established according to a data download speed at which data is downloaded in the local storage. Also, the new window size can be established according to a buffer size of a playback system.

In case that a data download time for downloading data according to the window size is longer than a maximum allowable delay time, the method can further comprise the step of terminating the data reproduction. The maximum allowable delay time can be determined by a playback system.

In another aspect of the present invention, there is provided an apparatus for reproducing data from a recording medium using a local storage comprising: a pickup for reading information of the recording medium; a pickup for reading information of the recording medium; a local storage for storing downloaded data associated with the recording medium; and a controller for downloading the data according to a window size, and starting data reproduction by a PlayList which is capable of being played while the data is downloaded, pausing the data reproduction when a reproduction position reaches a missing data point, and establishing a new window size larger than the window size. The controller can download data according to the new window size and resume the data reproduction.

The controller can establish a new window size whenever the reproduction position reaches the missing data point.

The new window size can be acquired by weighting a previous window size (Hᵢ₋₁) with a predetermined weighted value. The weighted value can be newly determined whenever the reproduction position reaches the missing data point.

The new window size (Hᵢ) can be acquired by adding a previous window size (Hᵢ₋₁) to a value obtained by multiplying a weight constant (α) and a weight function β(Hᵢ₋₁).

Also, the new window size (Hᵢ) can be acquired by multiplying a weight constant (α) and a weight function β(Hᵢ₋₁) associated with a previous window size (Hᵢ₋₁).

The new window size can be established according to a data download speed at which data is downloaded in the local storage or can be established according to a buffer size of a playback system.

A data download time for downloading data according to the window size may be longer than a maximum allowable delay time. In this case, the controller can terminate the data reproduction. The maximum allowable delay time can be determined by a playback system.

It is to be understood that both the foregoing general description and the following detailed description of the present invention are exemplary and explanatory and are intended to provide further explanation of the invention as claimed.

### BRIEF DESCRIPTION OF THE DRAWINGS

The accompanying drawings, which are included to provide a further understanding of the invention and are incorporated in and constitute a part of this application, illustrate embodiment(s) of the invention and together with the description serve to explain the principle of the invention. In the drawings:

FIG. 1 is a conceptual diagram illustrating a method and apparatus for reproducing data from a recording medium according to the present invention;

FIG. 2 is a conceptual diagram illustrating a file structure recorded in an optical disc acting as a recording medium and a method for reproducing a specific title using the file structure;

FIG. 3 is a structural diagram illustrating a data record structure of an optical disc acting as a recording medium according to the present invention;

FIG. 4 is a block diagram illustrating an optical recording/reproducing device according to the present invention;

FIG. 5 is a conceptual diagram illustrating a method for forming a virtual package according to the present invention;

FIG. 6 is a structural diagram illustrating an apparatus for reproducing data of a recording medium using a playback system according to the present invention;

FIG. 7 is a structural diagram illustrating a PlayList and its execution example for reproducing the PlayList according to the present invention;

FIG. 8 shows an example in which a reproduction point arrives at a missing data point while a PlayList is reproduced according to the present invention;

FIGS. 9A˜9D show execution examples of a PlayList according to the present invention; and

FIG. 10 is a flow chart illustrating a method for executing a PlayList according to the present invention.

### DETAILED DESCRIPTION OF THE INVENTION

Reference will now be made in detail to the preferred embodiments of the present invention, examples of which are illustrated in the accompanying drawings. Wherever possible, the same reference numbers will be used throughout the drawings to refer to the same or like parts.

A method and apparatus for reproducing data from a recording medium using a local storage will hereinafter be described with reference to the annexed drawings.

For the convenience of description and better understanding of the present invention, the optical disc, such as a BD, will hereinafter be exemplarily used as the above-mentioned recording medium in the present invention. It should be noted that technical ideas of the present invention can be applied to other recording mediums without departing from the scope and spirit of the invention.

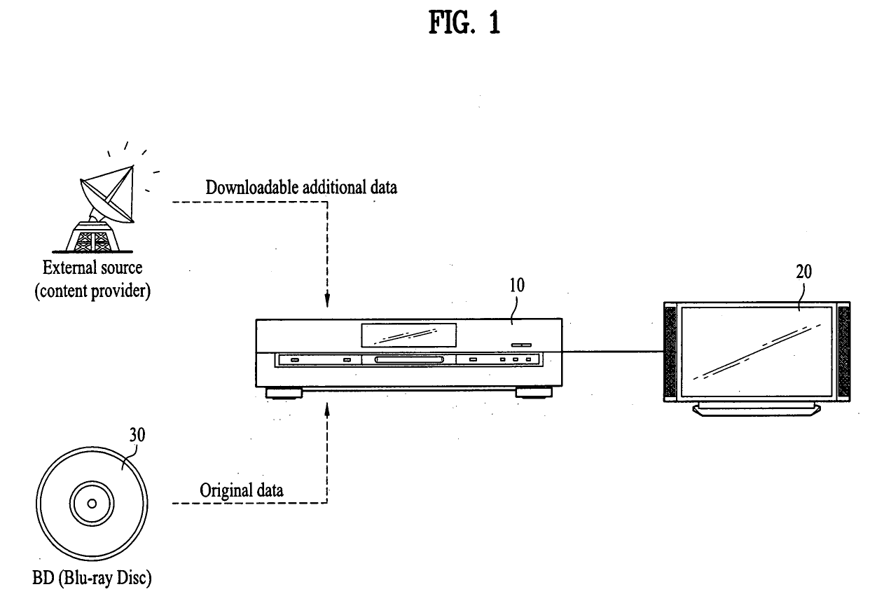

The term “local storage” is indicative of a storage unit contained in an optical recording/reproducing device 10 shown in FIG. 1. In more detail, the term “local storage” is indicative of a component capable of receiving necessary information or data from a user, and storing the received information or data. For example, a general local storage may be indicative of a Hard Disc Drive (HDD), but it should be noted that the term “local storage” of the present invention is not limited to the HDD, and is applicable to other examples as necessary.

Particularly, the term “local storage” is indicative of a storage unit for storing data associated with a recording medium such as a BD. The data associated with the recording medium is generally downloaded from an external device.

In association with the above-mentioned description, it is obvious to those skilled in the art that the local storage may directly read some permission data from the recording medium, and may generate system data (e.g., metadata) associated with record/reproduction operations of the recording medium, such that the system data may be stored in the local storage.

The term “binding unit” is indicative of a set of files stored in the local storage. Particularly, the binding unit is indicative of a set of information (i.e., information set) associated with a specific recording medium. In this case, the information set is combined with or is added to a file contained in the recording medium, such that it can simultaneously reproduce data of the recording medium and data of the local storage.

For the convenience of description, data recorded in the recording medium is referred to as “original data”, data associated with the recording medium from among a plurality of data units stored in the local storage is referred to as “additional data”.

The term “Title” is indicative of a reproduction unit interfacing with a user, and each title is linked to a specific object file, such that a stream associated with a corresponding title recorded in a disc is reproduced according to a command or program stored in the object file. Particularly, for the convenience of description and better understanding of the present invention, a first title in which movies and interactive information according to an MPEG2 compression scheme are recorded is called an HDMV title, and a second title in which movies and interactive information according to a Java program are recorded is called a BD-J title.

FIG. 1 is a conceptual diagram illustrating a method and apparatus for reproducing data according to the present invention. Unified usages of the optical recording/reproducing 10 and peripheral devices are shown in FIG. 1.

The optical recording/reproducing device 10 can record/reproduce data in/from various optical discs having different formats. If necessary, the optical recording/reproducing device 10 can record/reproduce specific data in/from only a specific optical disc such as a BD, or can reproduce the data from the optical disc without recording the data in the same. It should be noted that the present invention exemplarily uses a BD-player capable of reproducing data from the BD or a BD-recorder capable of recording data in the BD in consideration of correlation between the BD and peripheral devices for the convenience of description. In association with the above-mentioned description, it is well known in the art that the optical recording/reproduction device 10 is also applicable to a drive embedded in a specific device such as a computer.

The optical recording/reproducing device 10 records or reproduces data in/from the optical disc 30, receives an external input signal, performs a signal process on the received signal, and transmits the signal processed result to the external display 20, such that a user can view the signal processed result on the display 20. In this case, there is no limitation in a receivable external signal. For example, representative external input signals may be determined to be a DTV (Digital multimedia broadcasting TV)-associated signal and an Internet-associated signal, etc. Specifically, the Internet is indicative of a communication network to which a user easily gains access, such that the user can download specific Internet data using the optical recording/reproducing device 10, and can use the downloaded data.

In association with the above-mentioned description, a person for providing content data used as an external source is generally referred to as a content provider (CP).

The term “Content” is indicative of content data of the title, and is equal to data received from an author of a recording medium.

When original data is recorded in the optical disc 30 seated in the optical recording/reproducing device 10, and additional data associated with the original data is present in other storage places (e.g., Internet), the present invention aims to reproduce the additional data using the local storage.

For example, it is assumed that multiplexed AV (Audio/Video) streams are recorded as the original data recorded in the optical disc, and additional data for use in the Internet is an audio stream different from an audio stream (e.g., Korean) of the original data. In this case, some users may download specific audio stream (e.g., English) acting as additional data from the Internet, may desire to reproduce the downloaded audio stream along with the AV stream acting as original data, or may desire to reproduce only the additional data. In order to implement the above-mentioned desires of the users, correlation between the original data and the additional data must be established, and there is needed a systemized method for managing/reproducing the above-mentioned data according to a user request.

For the convenience of description, although a signal recorded in the disc is referred to as the original data, and other signals existing in the outside of the disc are referred to as the additional data, it should be noted that the original data and the additional data classified according to their data acquisition methods are not limited to only specific data.

Generally, additional data may be indicative of audio data, presentation graphic (PG) data, interactive graphic (IG) data, or text subtitle, etc., but the additional data may also be indicative of a multiplexed AV stream including the above-mentioned data and video data. In other words, data associated with the original data simultaneously existing in the outside of the optical disc may act as additional data.

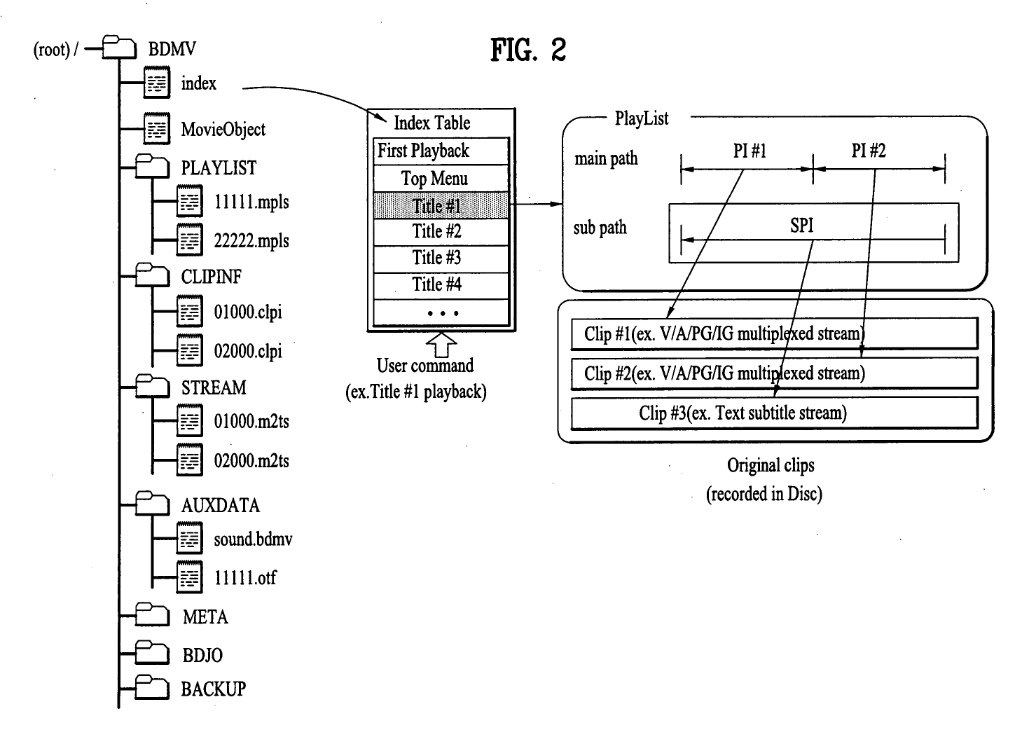

In order to satisfy the above-mentioned user requests, a predetermined file structure must be established between the original data and the additional data. Accordingly, a file structure and data record structure for use in the BD will hereinafter be described with reference to FIGS. 2˜3.

FIG. 2 is a conceptual diagram illustrating a file structure for reproducing/managing the original data recorded in an optical disc, and a method for reproducing a specific title according to the file structure.

Referring to FIG. 2, the file structure according to the present invention includes one or more BD directories (BDMV) under a single root directory. The BD directory (BDMV) includes not only an index file “index” acting as a general file (i.e., an upper file) capable of guaranteeing user interactivity, but also the above-mentioned object. The file structure includes a variety of directories for storing information of actual data recorded in a disc and other information associated with a method for reproducing the data, for example, a PLAYLIST directory, a CLIPINF directory, a STREAM directory, an AUXDATA directory, a BDJO directory, a META directory, and a BACKUP directory. The above-mentioned directories and a variety of files included in the directory will hereinafter be described.

The META directory includes a metadata file acting as “Data about Data”. In other words, the META directory includes a search file and a metadata file for Disc Library and the like.

The BDJO directory includes a BD-J object file for reproducing a BD-J title.

The AUXDATA directory includes an additional data file for reproducing data of the disc. For example, the AUXDATA directory includes a “Sound.bdmv” file for providing a user with sound data when an interactive graphic function is executed, and an “11111.otf” file for providing the user with font information when data of the disc is reproduced.

The STREAM directory includes a plurality of AV stream files recorded in a disc according to a specific format. Generally, individual streams are recorded using an MPEG-2 based transport packet, and the STREAM directory uses extension names of stream files (01000.m2ts and 02000.m2ts) as a specific extension name “*.m2ts”. Particularly, if video/audio/graphic information from among the above-mentioned streams is multiplexed, the multiplexed information is called an AV stream, and a single title is composed of at least one AV stream file.

The CLIPINF directory is composed of a plurality of clip information files (01000.clpi and 02000.clpi) connected to the above-mentioned stream files on a one-to-one basis. Particularly, the clip information files (*.clpi) record attribute information and timing information of the stream files (*.m2ts) therein. The clip information files (*.clpi) connected to the stream files (*.m2ts) on a one-to-one basis are generically named a “Clip”. In other words, this means that a single clip is indicative of data composed of a stream file (*.m2ts) and a clip information file (*.clpi).

The PLAYLIST directory includes a plurality of PlayList files (*.mpls). Each PlayList file (*.mpls) includes one or more PlayItems and one or more SubPlayItems. Each PlayItem and each SubPlayItem are adapted to designate a playing interval during which a specific clip is reproduced. The PlayItem (PI) and the SubPlayItem (SPI) include information associated with a specific clip to be reproduced, i.e., information associated with a reproduction start time (IN-Time) and other information associated with a reproduction termination time (OUT-Time) of the specific clip.

In association with the above-mentioned description, a process for reproducing data using at least one PlayItem (PI) in the PlayList file is referred to as a main path, and a process for reproducing data using individual SubPlayItems (SPIs) is referred to as a sub-path. The PlayList file must contain a single main path. The PlayList file may contain at least one sub-path according to the presence or absence of the SubPlayItem (SPI) as necessary.

In conclusion, the PlayList file acts as a basic management file unit contained in overall management file structures for reproducing a desired clip by combination of one or more PlayItems.

The BACKUP directory stores a plurality of duplicate files, i.e., a duplicate file (also called “copied files”) of the index file “index” storing information associated with disc reproduction, a duplicate file of the object file “MovieObject”, duplicate files of all PlayList files (*.mpls) contained in the PLAYLIST directory, and duplicate files of all clip information files (*.clpi) contained in the CLIPINF directory. If the above-mentioned files (“index”, “MovieObject”, “*.mpls”, and “*.clpi”) are damaged, a disc reproduction process is also fatally damaged, such that the BACKUP directory is designed to pre-store duplicate files of the above-mentioned files as backup files.

In association with the above-mentioned description, a method for reproducing a specific title using the above-mentioned disc file structure is shown in FIG. 2.

If a user enters a title reproduction command in association with a title used as an index file (also called “index table”), reproduction of the title begins. A detailed description thereof will hereinafter be described.

The index file (index.bdmv) includes first playback information “First Playback” indicative of information associated with a first reproduction image when data of a corresponding disc is loaded, top menu information “Top Menu” for providing a menu image, and at least one title information “Title #1˜Title #n”.

If the optical disc 30 is loaded in the optical recording/reproducing device 10, title menu information associated with the index table is provided to the user via the display 20. If the user selects a specific title or a specific menu contained in a menu image, data reproduction begins according to a scenario pre-defined by a disc manufacturer. In other words, if the user enters a command for reproducing a specific title (e.g., title #1), a specific PlayList file is executed (played) according to a command contained in the object file (MovieObject) of the management file structure. Thereafter, one or more clips (e.g., Clip #1˜Clip #3) constructing the title #1 are reproduced by a specific PlayItem and/or SubPlayItem contained in the PlayList file according to the PlayList file information.

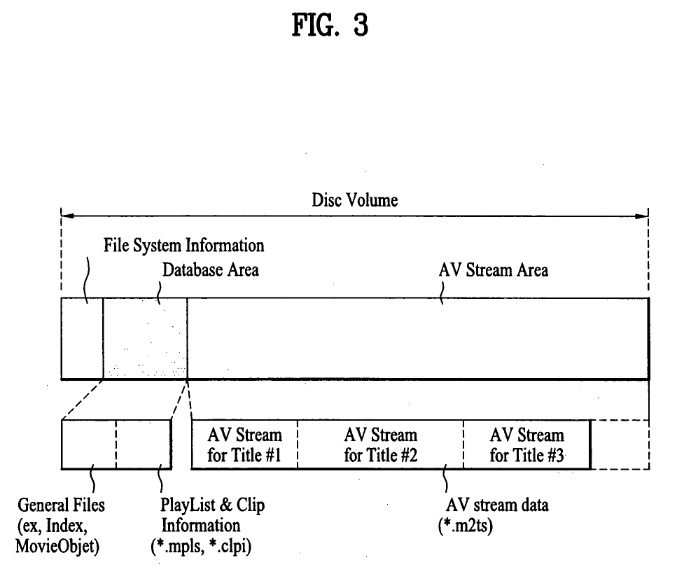

FIG. 3 is a structural diagram illustrating a data record structure recorded in a recording medium according to the present invention. In more detail, FIG. 3 shows a disc record format of information associated with the file structure.

As shown in FIG. 3, from the viewpoint of an inner area of the disc, the above-mentioned disc structure sequentially includes a file system information area serving as system information for managing overall files, a database area for recording a PlayList file and a clip information file to reproduce a recorded AV stream (*.m2ts), and an AV stream area for recording a plurality of streams composed of audio data, video data, and graphic data, etc. Particularly, it should be noted that data recorded in the AV stream area may be determined to be original data as previously stated above.

The present invention provides a method and apparatus for simultaneously reproducing original data (e.g., a file structure shown in FIG. 2) recorded in the disc and additional data recorded in the local storage, and a variety of preferred embodiments according to the present invention will hereinafter be described.

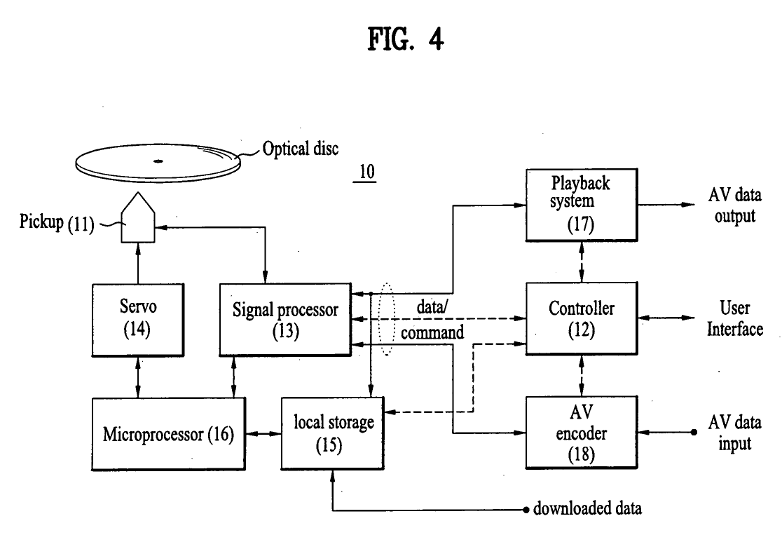

FIG. 4 is a block diagram illustrating the optical recording/reproducing device 10 according to the present invention.

Referring to FIG. 4, the optical recording/reproducing device 10 includes a pickup 11, a servo 14, a signal processor 13, and a microprocessor 16. The pickup 11 reproduces original data recorded in the optical disc and management information including reproduction/management file information. The servo 14 controls operations of the pickup 11. The signal processor 13 receives a reproduction signal from the pickup 11, restores the received reproduction signal to a desired signal value, or modulates a signal to be recorded into another signal recorded in the optical disc, such that it transmits the restored or modulated result. The microprocessor 16 controls overall operations of the above-mentioned components.

A controller 12 downloads additional data from outside of the optical disc upon receiving a command from a user, stores the downloaded additional data in the local storage 15, and configures a binding unit using Binding Unit Manifest Information recorded in a Binding unit manifest file of the local storage. In addition, the controller 12 configures a virtual file structure (hereinafter referred to as a virtual package) using the binding unit manifest information recorded in the binding unit manifest files, such that it can reproduce data contained in the recording medium and data contained in the local storage. The controller reproduces the original data and/or the additional data using the virtual package upon receiving a request from a user.

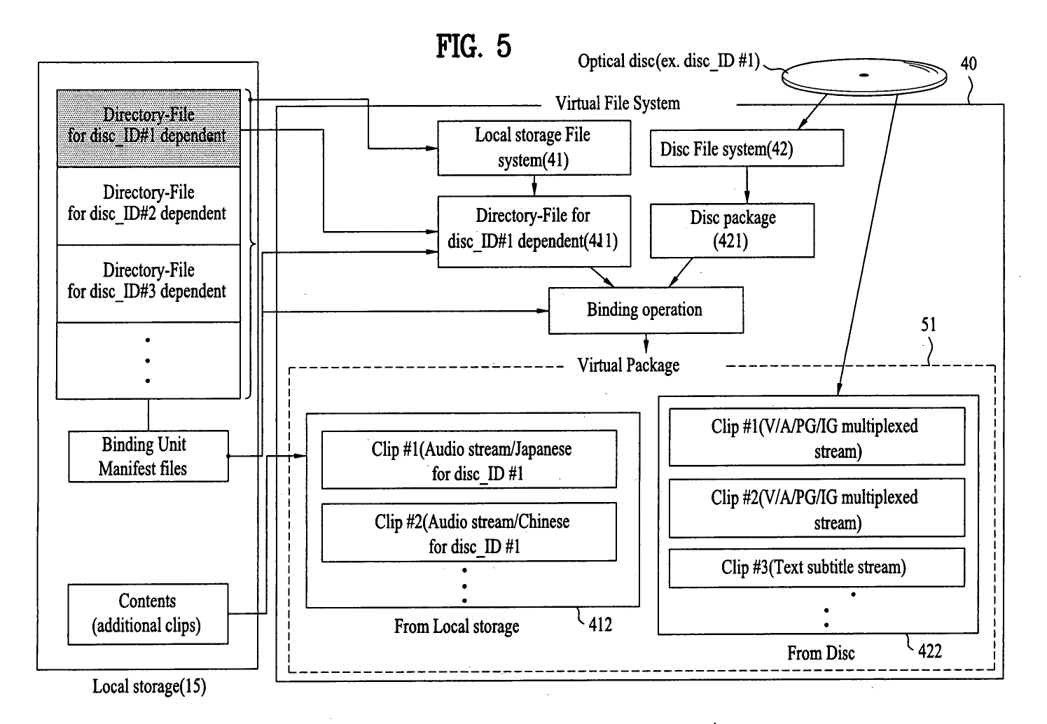

In association with the above-mentioned description, the binding unit manifest file, the name mapping information, and the virtual package will hereinafter be described with reference to FIG. 5.

The playback system 17 finally decodes output data (i.e., original data and/or additional data) upon receiving a control signal from the controller 12, and provides the user with the decoded result.

The AV encoder 18 converts an input signal into a specific format signal (e.g., an MPEG2 transport stream) upon receiving a control signal from the controller 12, and transmits the converted result to the signal processor 13.

The new virtual package may be stored in the local storage 15 such that it can be re-used in future. Also, the new virtual package may be temporarily stored in an additional dynamic memory, and may then be used.

FIG. 5 is a conceptual diagram illustrating a method for forming the virtual package according to the present invention.

Information stored in the local storage 15 will hereinafter be described. The local storage 15 according to the present invention stores file information (Directory-File for disc_ID #n dependent) including directories and files of individual disc identification (ID) information, and a plurality of additional clips downloaded from an external source. Also, the local storage 15 may include a binding unit manifest file for forming a binding unit of the local storage 15, and performing a binding operation associated with a disc package.

Specifically, the local storage 15 may include a plurality of file information units (Directory-File for disc_ID #n dependent) to cope with different discs. Therefore, the local storage 15 additionally requires a file system for managing the above-mentioned file information units. Specifically, the file system is also referred to as a local storage file system 41, and the local storage file system 41 is indicative of a system for managing all files stored in the local storage 15.

Therefore, if an optical disc (e.g., disc_ID #1) of a specific disc ID (disc_ID) is loaded in the optical recording/reproducing device 10, the controller 12 contained in the optical recording/reproducing device 10 recognizes ID information of the disc using the pickup 11 and the signal processor 13. If the local storage 15 stores file information, the controller reads binding unit file information equal to the loaded disc ID information from among all file information units stored in the local storage 15, forms a virtual package by binding (or combining) the read information and the disc package, and reproduces both the original data of the disc and the additional data of the local storage using the formed virtual package.

In association with the above-mentioned description, if no binding unit exists in the local storage 15, the optical recording/reproducing device forms the virtual package using only the loaded disc package. Thereafter, the optical recording/reproducing device may download data from an external source, may form a binding unit, and may form a virtual package.

If a specific disc is loaded in the optical recording/reproducing device 10 on the condition that the information and content data are stored in the local storage 15, the optical recording/reproducing device 10 reads the file system information 41 contained in the local storage 15, and at the same time reads disc file system information 42 including the file structure recorded in the disc, resulting in the creation of the VFS. In more detail, the virtual file system (VFS) is indicative of a file system virtually formed to manage both the file system contained in the local storage 15 and the other file system of the loaded disc.

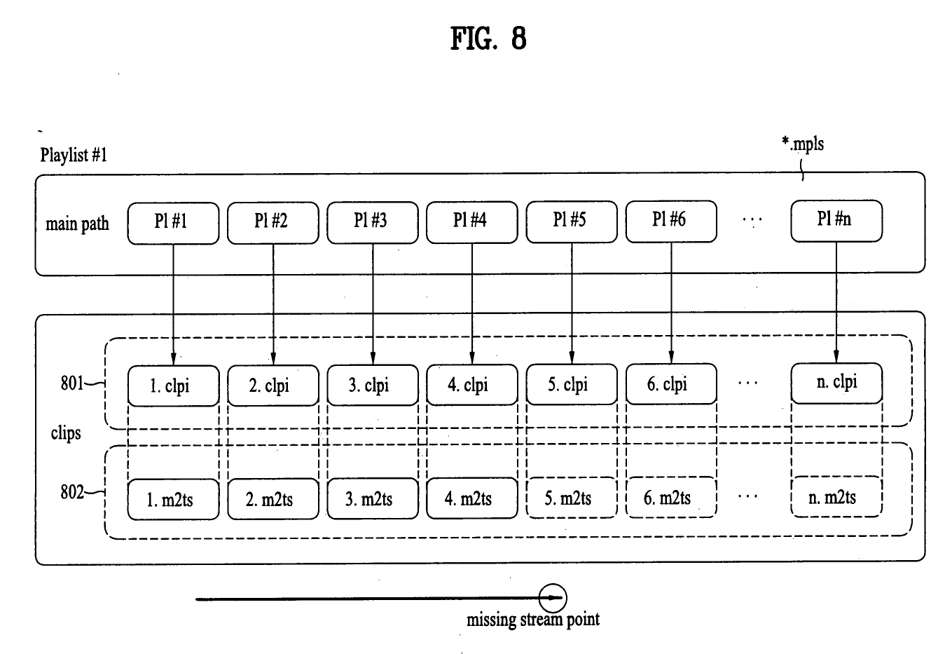

The optical recording/reproducing device forms a new virtual package to simultaneously reproduce original data recorded in the disc and additional data recorded in the local storage using the above-mentioned virtual file system (VFS). For this purpose, the optical recording/reproducing device 10 reads file information (Directory-File for disc_ID #1 dependent) associated with the disc (e.g., disc_ID #1) from the file system, forms a binding unit according to the read binding unit manifest information, reads the formed binding unit, and performs a binding operation for replacing the read file information with a disc package of the loaded disc (disc_ID #1) according to either name mapping information or Progressive PlayList information recorded in the binding unit manifest file, or appending the read file information to the disc package according to either name mapping information or Progressive PlayList information recorded in the binding unit manifest file. A detailed description of the Progressive PlayList will be described with reference to the annexed drawings from FIG. 7.

The binding unit manifest file includes name mapping information. The name mapping information includes a variety of information associated with the binding unit. For example, the name mapping information includes list information of files contained in the binding unit, location information where the files of the binding unit are located in the virtual package when the binding unit is combined with the disc, and file name information in the virtual package, etc.

Therefore, the virtual file system (VFS) performs a binding operation for combining the binding unit with the disc package of the loaded disc using the above-mentioned binding unit manifest information, such that it forms a new virtual package.

“Files and Titles Relation List” information, “Progressive PlayList” information, and “Credential” information are contained in the binding unit manifest file. The aforementioned “Files and Titles Relation List” information are adapted to delete/verify data in title units. The aforementioned “Credential” information is adapted to bind or combine files shared by different content providers with each other.

In association with the above-mentioned description, the virtual package formed by the aforementioned binding operation is indicative of a file structure for reproducing/managing an original clip 422 and an additional clip 412. The original clip 422 is composed of original data recorded in the disc. The additional clip 412 is composed of additional data recorded in the local storage.

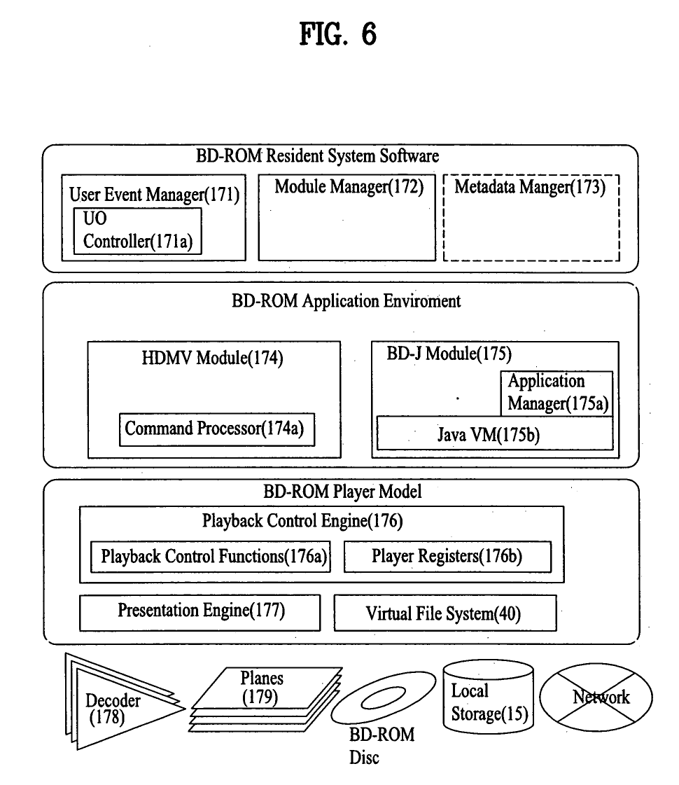

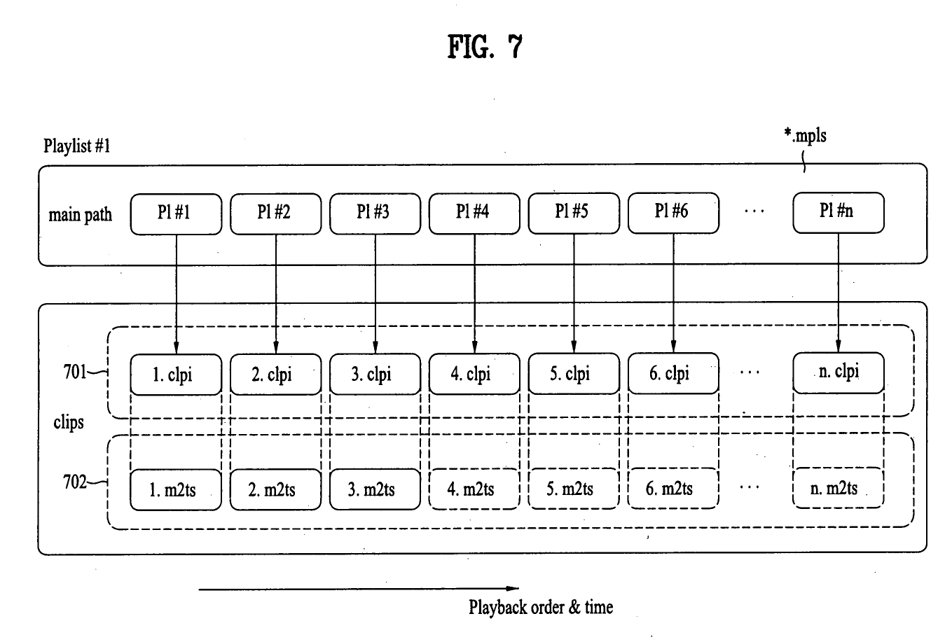

FIG. 6 is a block diagram illustrating an apparatus for reproducing data from a recording medium using a playback system 17 according to the present invention.

In association with the above-mentioned description, the term “playback system” is indicative of a collective reproduction processor implemented by software and/or hardware contained in the optical recording/reproducing device. The playback system is indicative of a system which reproduces data of a recording medium loaded in the optical recording/reproducing device, and at the same time reproduces/manages data (e.g., data downloaded from an external source) stored in the local storage in association with the recording medium.

Specifically, the playback system 17 includes a user event manager 171, a module manager 172, an HDMV module 174, a BD-J module 175, a playback control engine 176, a presentation engine 177, and a virtual file system 40. A detailed description thereof will hereinafter be described.

The HDMV module 174 acting as an additional reproduction process module capable of reproducing the HDMV title and the BD-J module 175 acting as an additional reproduction process module capable of reproducing the BD-J title are constructed independently of each other. The HDMV module 174 receives a command or program contained in the above-mentioned object “Movie Object”, and the BD-J module 175 receives a command or program contained in the above-mentioned object “BD-J Object”, such that the HDMV module 174 and the BD-J module 175 process the received command or program. The HDMV module 174 includes a command processor 174a, and the BD-J module 175 includes an application manager 175a and a JAVA VM 175b, such that the HDMV module 174 and the BD-J module 175 can receive/process the above-mentioned command.

The playback system includes the module manager 172, the playback control engine 176, and the presentation engine 177. The module manager 172 transmits a user command to the HDMV module 174 and the BD-J module 175, and controls operations of the HDMV module 174 and the BD-J module 175. The playback control engine 176 analyzes PlayList file content data recorded in a disc upon receiving a reproduction command from the HDMV module 174 and the BD-J module 175, and performs a reproduction function on the basis of the analyzed result. The presentation engine 177 decodes/displays a specific a specific stream reproduced/managed by the playback control engine 176.

Specifically, the playback control engine 176 is classified into a playback control function 176a for managing all the reproduction operations, and a player register 176b for storing player status register (PSR) information and general purpose register (GPR) information. The playback control function 176a may also be indicative of the playback control engine 176 as necessary.

In association with the above-mentioned description, the playback control engine 176 can access one of a plurality of smaller clips contained in the Progressive PlayList while another clip is downloaded.

The module manager 172, the HDMV module 174, the BD-J module 175, and the playback control engine 176 contained in the playback system can be processed by software. It is preferable that the above-mentioned components 172, 174, 175, and 176 are processed by software instead of hardware. The presentation engine 177, the decoder, and the planes are generally hardware based. Constituent components (e.g., 172, 174, 175, and 176) processed by software may be integrated in one unit, such that the integrated unit may be installed into the controller 12. Therefore, it should be noted that the above-mentioned components of the present invention be understood on the basis of their meanings, and are not limited to their implementation methods such as hardware or software implementation.

In association with the above-mentioned description, the characteristics of the playback system 17 are as follows.

Firstly, as stated above, the HDMV module 174 for the HDMV title and the BD-J module 175 for the BD-J title are configured independently of each other, and the two modules 174 and 175 cannot be executed at the same time. In more detail, the BD-J title cannot be reproduced when the HDMV title is reproduced, and the HDMV title cannot be reproduced when the BD-J title is reproduced.

Secondly, the playback system includes BD-J applications for actually managing the local storage 15, such that the BD-J applications can manage a network function contained in the optical recording/reproducing device in the same manner as in additional data downloaded from an external source, and can form a virtual package by editing files stored in the local storage 15 or combining the files with the disc package. In other words, the BD-J applications form a virtual file system (VFS) 40 capable of managing a disc file system and a local storage file system as a single system, and forms/manages the virtual package for reproducing original data and additional data using the virtual file system (VFS) 40. In association with the above-mentioned description, a method for forming the virtual package using the virtual file system (VFS) 40 has been previously stated above.

Thirdly, the HDMV title and the BD-J title receive user commands based on different schemes, respectively. The HDMV title and the BD-J title use different methods for performing individual user commands. There is needed a predetermined unit capable of receiving the user command, and transmitting the received user command to either the HDMV module 174 or the BD-J module 175. In this case, the above-mentioned operations are performed by the user event manager 171a. For example, if the received command is determined to be a user command entered by a User Operation (UO), the user event manager 171a transmits the user command to the module manager 172 or the UO controller 171a. Otherwise, if the received command is determined to be a user command entered by a key event, the user event manager 171a transmits the received user command to the Java VM 175b contained in the BD-J module 175.

Fourthly, one of the modules 174 or 175 manages the above-mentioned playback control engine 176 (also called a master). In more detail, when reproducing the HDMV title, the HDMV module 174 acts as a master of the playback control engine 176. When reproducing the BD-J title, the BD-J module 175 acts as a master of the playback control engine 176.

In association with the above-mentioned description, the playback system may include a metadata manager 173. The metadata manager 173 provides a user with the Disc Library and Enhanced Search Metadata Application.

A method for allowing the playback system 17 to use individual file information contained in the virtual package 51 formed by the binding operation will hereinafter be described. In association with the above-mentioned description, the virtual package 51 has the same directory and file as in the file structure of FIG. 2.

The index table contained in the virtual package 51 is transmitted to the module manager 172 contained in the playback system 17. If a user selects a specific title, the module manager 172 operates either the HDMV module 174 or the BD-J module 175 according to attribute information of a corresponding title. If the user-selected title is determined to be a movie title, the HDMV module 174 is executed by the movie object file. Otherwise, if the user-selected title is determined to be a BD-J title, the BD-J module 175 is executed by the BD-J object file.

The PlayList file contained in the virtual package 51 is transmitted to the playback control engine 176 of the playback system 17. The playback control engine 176 executes (plays) a corresponding PlayList by referring to the Player Registers 176b upon receiving a control signal of either one of the HDMV module 174 and the BD-J module 175.

The clip contained in the virtual package 51 is transmitted to the presentation engine 177 contained in the playback system 17, such that the decoder 178 contained in the presentation engine 177 reproduces the clip in the form of any one of video data, audio data, graphic data, and text subtitle data according to categories of stream data. The reproduced stream is visually applied to the user via the planes 179.

FIG. 7 is a structural diagram illustrating a PlayList and its execution example for reproducing the PlayList according to the present invention.

In association with the above-mentioned description, a PlayList reproducible using the local storage can be classified into two types (i.e., a first PlayList and a second PlayList). The first PlayList can be reproduced after all data reproduced by the PlayList has been completely downloaded. The second PlayList can be reproduced although data is completely downloaded, such that the remaining data can be downloaded simultaneously with reproducing pre-downloaded data. The present invention relates to the aforementioned second PlayList. Specifically, the Progressive PlayList shown in FIG. 5 corresponds to the second PlayList.

In association with the above-mentioned description, the PlayList may be a Disc-dependent PlayList or a Disc-independent PlayList. If the second PlayList is equal to the disc-dependent PlayList, a user can freely download/reproduce according to the second PlayList at any time, or the second PlayList can be reproduced by itself without being combined with a disc package. The present invention relates to the disc-dependent PlayList. According to the present invention, data associated with a specific disc is downloaded from an external source, and the downloaded data is combined with the disc package as previously stated above.

A method for reproducing data according to the aforementioned second PlayList will hereinafter be described with reference to FIG. 7. Specifically, a Progressive PlayList is used as an example in FIG. 7.

It is assumed that the virtual package exists before downloading data associated with a loaded disc from an external source in FIG. 7.

In association with the above-mentioned description, the virtual package may be formed from a disc package contained in the disc after the disc is loaded in the optical recording/reproducing device. Otherwise, the virtual package may be formed by combining data of the disc package with data of the local storage.

The virtual package may be updated by the data downloaded from the external source. A method for updating the virtual package after downloading some stream files will hereinafter be described in detail.

Referring to FIG. 7, a PlayList file (*.mpls) of the PlayList #1, the clip information file 701 of a clip reproduced (referenced) by the PlayList #1, and some parts (1.m2ts, 2.m2ts, and 3.m2ts) of the stream file 702 are downloaded before data is reproduced.

If a update request for updating the virtual package occurs when all data is not fully downloaded, the virtual package including the PlayList #1 is formed by the downloaded data (i.e., a PlayList file (*.mpls), a clip information file 701, and stream files 1, 2, and 3 (1.m2ts, 2.m2ts, and 3.m2ts)) according to the binding unit manifest file.

The aforementioned PlayList #1 is indicative of a PlayList capable of initiating a playback (reproduction) operation using some downloaded data. Therefore, after the virtual package is updated by the binding unit with missing stream files, the BD-J application can play the PlayList although all stream files required to play the PlayList are not in place. The missing stream data (4.m2ts˜n.m2ts) not downloaded before the virtual package is updated is downloaded while the virtual package is updated or while the Progressive PlayList #1 is reproduced.

In association with the above-mentioned description, the missing data means undownloaded data before data reproduction by a PlayList according to present invention. A missing stream file, a missing clip and etc. has similar meaning in hereinafter description.

After the missing stream data (4.m2ts˜n.m2ts) is stored at the location indicated by a binding unit manifest file, a BD-J application generates a request to play a specified clip. After the player receives the above-mentioned request, it does not need to wait for a predetermined time to pass until a title is changed to another title. The player sets specified stream data to be read only, and can immediately play a corresponding clip according to the name mapping information contained in the binding unit manifest file.

In association with the above-mentioned description, the data reproduced by the PlayList #1 may be referenced by Progressive PlayList information within the binding unit manifest file.

In association with the above-mentioned description, if data receiving a playback command is not equal to data specified by the Progressive PlayList information of the binding Unit Manifest file, or is determined to be pre-reproduced data, the aforementioned data receiving the playback command cannot be reproduced.

If a update request for the virtual package occurs when all data associated with the PlayList #1 is not fully downloaded, the virtual package including the PlayList #1 is generated using the downloaded data (i.e., a PlayList file (*.mpls), a clip information file 701, and stream files 1, 2, and 3 (1.m2ts, 2.m2ts, and 3.m2ts)) according to the binding unit manifest file.

The aforementioned PlayList #1 is indicative of a PlayList capable of being played before all the data is downloaded. Therefore, after the virtual package is updated by the binding unit with missing stream files, the BD-J application can play the PlayList although all stream files required to play the PlayList are not in place. The missing stream data (4.m2ts˜n.m2ts) not downloaded before the virtual package is updated is downloaded while the virtual package is updated or while the PlayList #1 is played.

The update request of the virtual package is executed by the BD-J applications. If the missing data downloaded after the PlayList starts its reproduction is stored in a specific location indicated by the binding unit manifest file, the BD-J applications may generate a command for reproducing the stored data, and may delete unnecessary data, which is not to be reproduced in the future, by referring to the binding unit manifest file.

The PlayList file (*.mpls) and the clip information file (*.clpi) may be downloaded before the PlayList #1 starts its reproduction. In other words, data, which is downloaded during the reproduction time of the PlayList #1 and is thus not downloaded before the reproduction begins, may be determined to be stream data.

The stream reproduced by the PlayList #1 may be determined to be a downloaded stream instead of a stream recorded in a recording medium. In other words, the PlayList #1 should be treated as a new title that is bound to a disc. After, streaming and playback operations are performed, the PlayList #1 may be treated as a normal BD-J title.

FIG. 8 shows an example in which a reproduction position (playback position) arrives at a missing data point while a PlayList is reproduced according to the present invention.

As previously stated in FIG. 7, the PlayList according to the present invention can be executed although not all data reproduced by the aforementioned PlayList is downloaded in the local storage. In other words, the BD-J applications can play the PlayList #1 even if the PlayList #1 includes missing clips. Therefore, a current playback position may arrive at the missing data point (hereinafter referred to as a missing data point) while the PlayList #1 is executed. For example, if a playback position reaches a specific point at which the missing stream must be reproduced during the execution time of the aforementioned PlayList, or if a playback position jumps to the missing stream part according to a user command, it is determined that the reproduction position or the playback position reaches the aforementioned missing data point.

FIG. 8 shows an example in which the playback position reaches a specific point at which the missing stream must be reproduced while streams reproduced by the PlayList #1 are sequentially reproduced. A detailed description of the aforementioned example is as follows.

The PlayList file (*.mpls) and the clip information file 801 have been already downloaded before the PlayList #1 is executed.

In association with the above-mentioned description, the execution starting of the aforementioned PlayList is allowed after the clip reproduced by the PlayList is downloaded according to a window size.

The term “Window Size” is indicative of an amount of data, which must be downloaded before a data reproduction by a PlayList according to present invention starts or resumes, wherein the PlayList is capable of being played (executed) while missing data is downloaded. It should be noted that the aforementioned window size can be represented in various ways without departing from the scope and spirit of the invention, for example, a downloaded time, a data size, or the number of clips, etc.

In association with the above-mentioned description, the window size may be set to different values according to a data download speed at which data is downloaded from an external source to the local storage, or a player buffer size, etc.

If the window size is determined to be the number of clips, and the number of clips is determined to be “2”, the execution of the PlayList #1 shown in FIG. 8 can begin after the two streams (1.m2ts and 2.m2ts) are downloaded.

If the PlayList #1 of FIG. 8 is executed, the streams 802 reproduced by the PlayList #1 are sequentially decoded/displayed from the first stream file (1.m2ts) to the last stream file (n.m2ts). The streams not downloaded before the PlayList #1 is executed are downloaded in the local storage while the PlayList #1 is executed, such that they are reproduced in a playback order specified by the PlayList #1, as previously stated in FIG. 7.

If external data is smoothly downloaded and all data exists in the local storage at a specific moment at which corresponding data must be reproduced, the range of data reproduction reaches the end of the aforementioned PlayList #1. However, if the data download speed is lower than a data playback speed (e.g., if a network enters a congested state or if a network has a small transport bandwidth), a fifth stream (5.m2ts) may not be downloaded in the local storage at a specific time at which the fifth stream (5.m2ts) should be reproduced after first to fourth streams (1.m2ts˜4.m2ts) are reproduced.

In association with the above-mentioned description, in the case where a playback position reaches the missing data point during the execution time of the PlayList capable of downloading data from an external source to the local storage simultaneously with reproducing the downloaded data, a data playback by the PlayList may pause according to the present invention. In other words, if the playback position reaches the missing stream point during the playback operation, the player changes the media player and the Playback Control Engine to a stopped state. If the playback position is changed to the missing clip point by a jump operation of a user, the playback operation may stop at the jumped place and then the stop event may be transmitted to the BD-J application. If the BD-J application specifies a playback position with the missing stream, the player may change the media player and the Playback Control Engine to a stopped state.

The present invention continuously downloads data on the condition that the data reproduction by execution of the PlayList pauses, and resumes the data playback operation after data is downloaded according to a window size.

The BD-J application can pause an AV playback operation before reaching the missing data, because the BD-J application downloads the clip files and recognizes the playback position. After pausing the AV playback operation, the BD-J application can restart the AV playback operation when the clip is completely downloaded. However, if a network enters a congested state or has a low transport bandwidth, the operation for immediately resuming the playback operation after the missing clip is completely downloaded may incur other exception due to the lack of available clips. Also, due to the latency time of the decoder, there is a need for the player to read data in advance which should be reproduced.

Therefore, the present invention establishes a window size, and resumes the paused data playback after data is downloaded according to the window size, such that it can effectively reproduce additional data downloaded in the local storage in association with a recording medium.

In addition, if a playback position reaches the missing data point while the PlayList is played, the present invention gives the window size a weight. The aforementioned operation for assigning the weight to the window size may be performed whenever a playback position reaches the missing data point.

In more detail, although the data playback pauses at the missing data point while the PlayList is executed, and corresponding data is downloaded such that the paused data reproduction resumes, the playback position may again reach the missing data point on the assumption that a data download speed does not satisfy a playback speed of the data reproduced by the PlayList. In other words, if the window size is maintained at the initial window size, the user may frequently experience the occurrence of the pause of data reproduction. As a result, it is preferable that the window size is weighted whenever the playback position reaches the missing data point.

The present invention assigns a weight to the window size to prevent the playback operation of the PlayList from being frequently interrupted by the delay of data downloading. Therefore, the present invention allows the user to experience a relatively-seamless playback operation.

A method for weighting the window size can be represented by the following equations 1 and 2:
Hₒ=α
HᵢHᵢ₋₁+δ*β(Hᵢ₋₁) [Equation 1]
Hₒ=α
Hᵢ=δ*β(Hᵢ₋₁) [Equation 2]

With reference to Equations 1 and 2, α is indicative of a initial window size. The execution of the inventive PlayList is allowed when data is downloaded according to the initial window size α.

With reference to Equations 1 and 2, Hᵢ is indicative of a window size established when the player resumes data reproduction i-th, β(Hᵢ₋₁) is indicative of a weight function of the window size Hᵢ₋₁, δ is indicative of a weight constant. The weighting degree of the window size is changed according to the weight function and the weight constant.

In association with the above-mentioned description, the Equation 1 shows a embodiment in which a previous window size (Hᵢ₋₁) is added to value obtained by multiplying the weight constant δ and the weight function β(Hᵢ₋₁) associated with the previous window size (Hᵢ₋₁), such that a new window size Hᵢ larger than the previous window size Hᵢ₋₁ is established.

The Equation 2 shows a preferred embodiment in which the value obtained by multiplying the weight constant δ and the weight function β(Hᵢ₋₁) associated with the previous window size (Hᵢ₋₁) is determined to a new window size Hᵢ.

In association with the above-mentioned description, the present invention is not limited to the aforementioned example in which the window size is weighted according to the aforementioned equations, and can be implemented in various ways within the scope and spirit of the present invention.

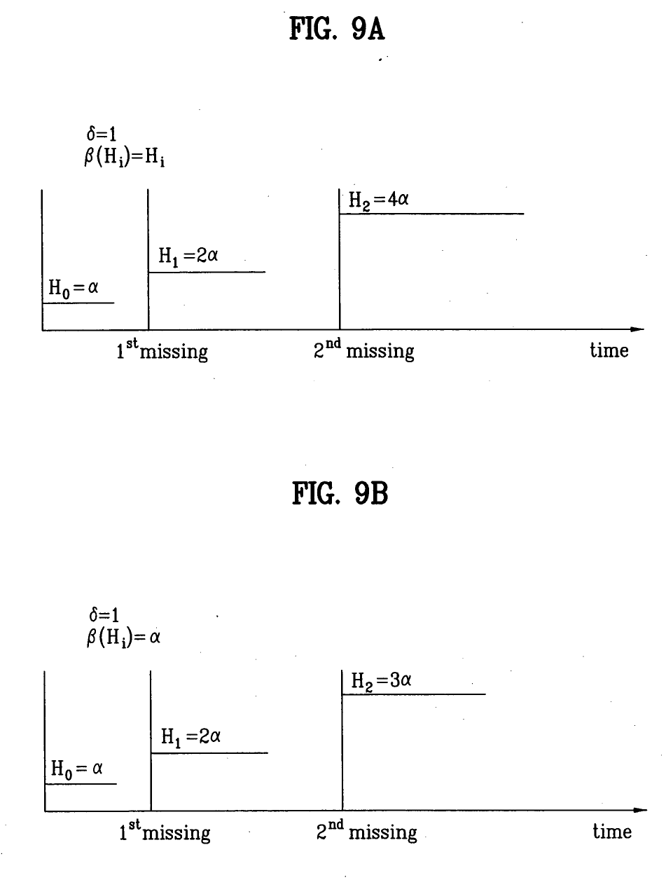

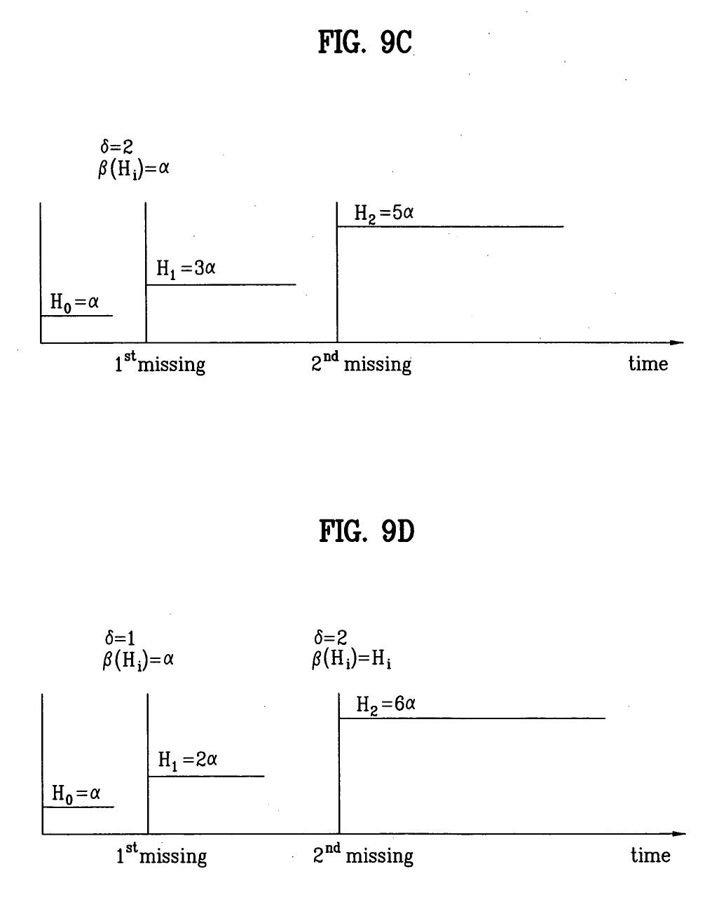

A method for starting the execution of the PlayList and resuming the data playback which has pased in association with the aforementioned Equation 1 will hereinafter be described with reference to FIGS. 9A˜D.

FIGS. 9A˜9D show execution examples of a PlayList according to the present invention.

FIGS. 9A˜9C show embodiments in which a window size larger than a previous window size is established by a constant weighted value. FIG. 9D shows an embodiment in which a window size larger than a previous window size is re-established by a weighted value which is newly established whenever the data playback pauses.

FIG. 9A shows an example in which the weight constant δ is set to “1” and the weighted function β(Hᵢ) is set to Hᵢ. FIG. 9B shows an example in which the weight constant is set to “1” in the same manner as in FIG. 9A, but the weight function is set to α. FIG. 9C shows an example in which the weight function is equal to the constant function in the same manner as in FIG. 9B, but the weight constant is set to “2” larger than “1” of FIGS. 9A and 9D. A detailed description of the aforementioned examples will hereinafter be described.

FIG. 9A shows a method for reproducing data using the PlayList when the weight constant δ is set to “1” and the weight function β(Hᵢ) is denoted by β(Hᵢ)=Hᵢ.

If data is downloaded according to the initial window size α, the PlayList of the present invention can be executed. When a playback position reaches a first missing data point (denoted by “1st missing”) during the execution time of the PlayList, the data playback according to the PlayList pauses. In this case, the value obtained by multiplying the weight constant (δ=1) and the weight function (β(H₀)=H₀=α) is weighted to a initial window size (Hₒ=α), such that the window size Hᵢ is reset to 2α(=Hᵢ). The paused data playback can be resumed after data is downloaded according to the weighted window size.

If a data download speed is less than a playback speed of data reproduced by the PlayList during the playback time of resumed data, the playback position may re-arrive at the missing data point. In this case, the weighted window size is re-weighted according to the present invention. In more detail, if the playback position reaches a second missing data point (denoted by “2nd missing”) in FIG. 9A, the value obtained by multiplying the weight constant (δ=1) and the weight function (β(H₁)=H₁=2α) is added to the window size 2α acquired when the playback position reaches the first missing data point, such that the window size H₁ is weighted to be 4α(=H₂). Therefore, the playback of the secondly-paused data can be resumed after data is downloaded according to a value of 4α.

FIG. 9B shows a method for executing the PlayList when the weight constant δ is set to “1” and the weight function β(Hᵢ) is denoted by α(Hᵢ)=α.

If data is downloaded according to the initial window size α, the PlayList of the present invention can be executed. When a playback position reaches a first missing data point (denoted by “1st missing”) during the execution time of the PlayList, the data playback by the PlayList pauses. In this case, the window size Hᵢ is reset to 2α(=Hᵢ) in the same manner as in FIG. 9A, and the playback of data by the PlayList can be resumed after the data is downloaded according to a value of 2α.

When a playback position reaches a second missing data point (denoted by “2nd missing”, the playback of data re-pauses, and the weighted window size 2 α is re-weighted. In more detail, if the playback position reaches the second missing data point (i.e., “2nd missing” in FIG. 9B), the value obtained by multiplying the weight constant (δ=1) and the weight function (β(Hᵢ)=α) is added to the window size 2α acquired when the playback position reaches the first missing data point, such that the window size H₁ is weighted to be 3α(=H₂). Therefore, the playback of the secondly-paused data can be resumed after data is downloaded according to a value of 3α.

FIG. 9C shows a method for executing the PlayList when the weight constant δ is set to “2” and the weight function β(Hᵢ) is denoted by α(Hᵢ)=α.

In the same manner as in FIGS. 9A and 9B, the PlayList according to the present invention can be executed when data is downloaded according to the initial window size α. When a playback position reaches a first missing data point (denoted by “1st missing”) during the execution time of the PlayList, the data playback based on the PlayList pauses.

If the playback of data based on the PlayList pauses, the value obtained by multiplying the weight constant (δ=1) and the weight function (β(H₀)=α) is weighted to the initial window size (H₀=α), such that the window size Hᵢ is reset to 3α(=Hᵢ). The paused PlayList can resume the playback of data when data is downloaded according to a value of 3α.

If a data download speed is less than a playback speed of data reproduced by the PlayList during the playback time of resumed data, and the playback position may reach the missing data point (i.e., 2nd missing), the value obtained by multiplying the weight constant (δ=2) and the weight function (β(H₁)=α) is added to the window size 3α, such that the window size H₁ is re-weighted to be 5α(=H₂). In conclusion, the playback of the PlayList secondly-paused by the missing data can be resumed after data is downloaded according to a value of 5α.

FIG. 9D shows a method for executing the PlayList when the weight constant δ and the weight function β(Hᵢ) are changed whenever the data reproduction pauses.

In the same manner as in FIGS. 9A to 9C, if data is downloaded according to the initial window size α, the data reproduction can begin. If a data download situation grows worse while the PlayList is executed, the playback position reaches the missing data point (i.e., 1st missing), and the data reproduction by the PlayList may pause.

If the data reproduction pauses, a data download speed is recognized, such that it is determined how much data is pre-downloaded to successively perform the data playback operation. Thereafter, the weight constant and the weight function are determined, such that the window size is changed to a weighted value. If the execution of the PlayList firstly pauses in FIG. 9D, the weight constant is determined to be “1” and the weight function is determined to be β(Hᵢ)=α. Therefore, if the initial window size α is weighted according to the aforementioned Equation 1, the value of Hᵢ is changed to 2α.

If the playback of data based on the PlayList secondly pauses, the weight constant is determined to be “2” and the weight function is determined to be β(Hᵢ)=H₁. Therefore, if the window size is weighted according to the aforementioned Equation 1, the value of the window size is changed to 6α. Therefore, in order to resume the paused data reproduction, the player must download a large amount of data, which is six times greater than an amount of initial data according to the initial window size.

In association with the above-mentioned description, the weighting degree of the window size is changed according to a data download speed and a buffer size, etc.

FIGS. 9A˜9D show a variety of examples in which the playback position reaches the missing data point because a data download operation is delayed. Besides, there may be a demand for reproducing data not yet downloaded in the local storage while the PlayList is executed. For example, the playback position may jump to the missing stream according to a user command. In this case, the player may stop its execution and may terminate the playback of the PlayList. However, the player may allow the data reproduction to pause until corresponding data is downloaded in the local storage and enters a specific mode during which the data can be reproduced. In this case, such that there is no need to weight the window size because a data download speed is not changed to another speed. If a data download environment or a reproduction environment of a playback sysyte is changed to other environments during the execution time of the PlayList, a new window size is established such that the playback of data based on the paused PlayList can be resumed.

As previously stated above, if the playback position reaches the missing data point while the PlayList is executed, necessary operations are performed by the BD-J applications.

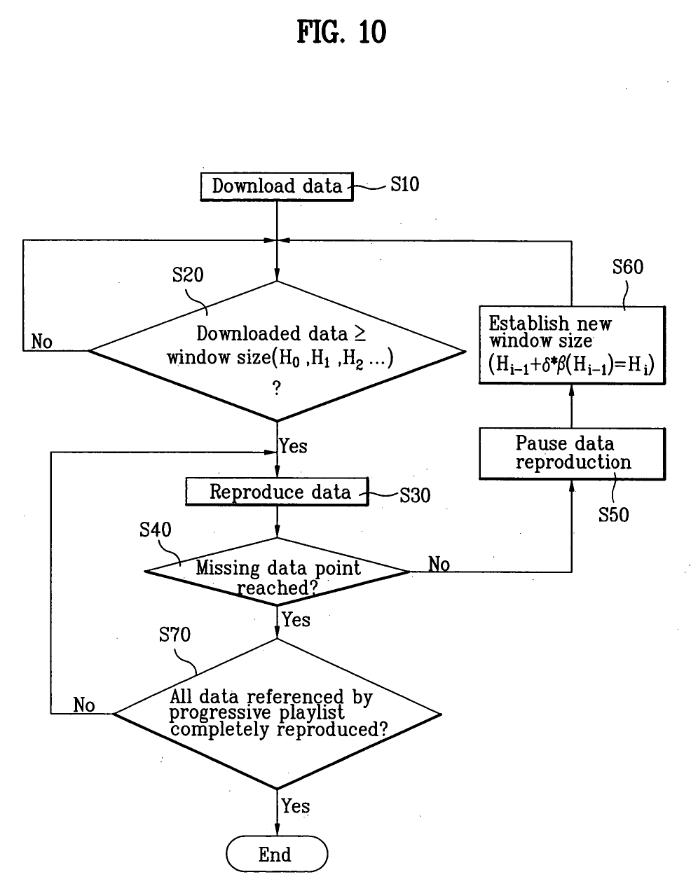

FIG. 10 is a flow chart illustrating a method for executing a PlayList according to the present invention. In more detail, FIG. 10 shows an example in which the window size is weighted according to the aforementioned Equation 1.

Data associated with a recording medium can be downloaded from an external source to the local storage. If the binding unit manifest file contained in the local storage contains information about the PlayList capable of reproducing downloaded data with downloading missing data referenced by the PlayList. Therefore, if the data download begins at step S10, and the downloaded data is downloaded according to the window size H₀ at step S20, the PlayList according to the present invention is executed, such that the data playback operation can begin at step S30.

If data is continuously downloaded, the downloaded data reproduction by the PlayList begins, and a playback position reaches the missing data point at step S40, the playback of data pauses at step S50, and a previous window size (Hᵢ₋₁: H₀, H₁, H₂, . . . ) is added to the value δ*β(Hᵢ₋₁) obtained by multiplying the weight constant and the weight function, such that a new window size (Hᵢ) is established at step S60.

If data is downloaded according to the new window size (Hᵢ) from a point at which the playback operation pauses at step S20, the playback of data can be resumed at step S30. According to the present invention, the data playback by the PlayList pauses at step S50 whenever the PlayList position reaches the missing data point at step S40, such that the new window size is established at step S60. The reference symbol Hᵢ is indicative of an i-th re-established window size, and H₀ is indicative of the initial window size.

If the playback position does not reach the missing data point at step S40 after the data playback by the PlayList begins or after the paused playback resumes, and all data of the PlayList is completely reproduced at step S70, the execution of the PlayList is terminated. Otherwise, if the playback of all data is not completed, the data playback is successively performed to the end of the PlayList at step S30.

If a data download time during which data is downloaded according to a window size is longer than a maximum allowable delay time, the present invention abandons the data reproduction operation by the PlayList. The maximum allowable delay time is indicative of a maximum waiting time during which a user can wait for the PlayList to be reproduced. In association with the above-mentioned description, the maximum allowable delay time can be determined by the playback system 17. If a data download speed is too slow to download data, the execution start time of the PlayList may be delayed for a very long period of time. Therefore, if the value of the maximum allowable delay time is established, it is prevented a user from waiting infinitely for data to be downloaded/reproduced. The user can reattempt to execute the PlayList at a later time.

In association with the above-mentioned description, in the case where the playback position reaches the missing data point during the execution time of the PlayList such that the playback pauses, the aforementioned maximum allowable delay time is available for the aforementioned case. In other words, the player may give up the execution of the PlayList and terminate data reproduction when a data download time is longer than the aforementioned maximum allowable delay time.

An apparatus for reproducing data from a recording medium using a local storage according to the present invention will hereinafter be described with reference to FIG. 4.

Referring to FIG. 4, the apparatus for reproducing data from the recording medium using the local storage includes a pickup 11, a local storage 15, and a controller 12. The pickup 11 reads data from the recording medium. The local storage 15 stores downloaded data associated with the recording medium. The controller 12 starts a data playback operation after the data is downloaded according to the window size. If a playback position reaches the missing data point during the data playback time, the controller 12 pauses the data playback operation, and establishes a new window size. The controller 12 can establish a new window size whenever the playback of data pauses. The present invention is characterized in that the new window size is larger than a previous window size. According to another embodiment of the present invention, the controller 12 stops the playback operation of the data if a data download time during which data is downloaded according to the window size is longer than the maximum allowable delay time. The maximum allowable delay time can be determined by the playback system 17.

As apparent from the above description, a method and apparatus for reproducing data from a recording medium using a local storage according to the present invention can effectively reproduce additional data, which is downloaded in the local storage in association with the recording medium, resulting in the creation of more convenient functions for a user.

It will be apparent to those skilled in the art that various modifications and variations can be made in the present invention without departing from the spirit or scope of the inventions. Thus, it is intended that the present invention covers the modifications and variations of this invention provided they come within the scope of the appended claims and their equivalents.

What is claimed is:

1. A method for reproducing data from a recording medium using a local storage comprising the steps of:
a) downloading data associated with the recording medium according to a window size in the local storage, and starting data reproduction by a PlayList which is capable of being played while the data is downloaded.
b) pausing the data reproduction when a reproduction position reaches a missing data point, and establishing a new window size larger than the window size.

2. The method according to claim 1, further comprising the step of:
c) downloading data according to the new window size, and resuming the data reproduction.

3. The method according to claim 1, wherein the new window size is re-established whenever the reproduction position reaches the missing data point.

4. The method according to claim 1, wherein the new window size (Hᵢ) is acquired by weighting a previous window size (Hᵢ₋₁) with a predetermined weighted value.

5. The method according to claim 4, wherein the weighted value is newly determined whenever the reproduction position reaches the missing data point.

6. The method according to claim 1, wherein the new window size (Hᵢ) is acquired by adding a previous window size (Hᵢ₋₁) to a value obtained by multiplying a weight constant (α) and a weight function β(Hᵢ₋₁).

7. The method according to claim 1, wherein the new window size (Hᵢ) is acquired by multiplying a weight constant (α) and a weight function β(Hᵢ₋₁) associated with a previous window size (Hᵢ₋₁).

8. The method according to claim 1, wherein the new window size is established according to a data download speed at which data is downloaded in the local storage.

9. The method according to claim 1, wherein the new window size is established according to a buffer size of a playback system.

10. The method according to claim 1, wherein the step of c) is performed by BD-J application.

11. The method according to claim 1, further comprising the step of:
in case that a data download time for downloading data according to the window size is longer than a maximum allowable delay time, terminating the data reproduction.

12. The method according to claim 11, wherein the maximum allowable delay time is determined by a playback system.

13. An apparatus for reproducing data from a recording medium using a local storage comprising:
a pickup for reading information of the recording medium;
a local storage for storing downloaded data associated with the recording medium; and
a controller for downloading the data according to a window size, and starting data reproduction by a PlayList which is capable of being played while the data is downloaded, pausing the data reproduction when a reproduction position reaches a missing data point, and establishing a new window size larger than the window size.

14. The apparatus according to claim 13, wherein the controller downloads data according to the new window size and resumes the data reproduction.

15. The apparatus according to claim 13, wherein the controller establishes a new window size whenever the reproduction position reaches the missing data point.

16. The apparatus according to claim 13, wherein the new window size is acquired by weighting a previous window size (Hᵢ₋₁) with a predetermined weighted value.

17. The apparatus according to claim 16, wherein the weighted value is newly determined whenever the reproduction position reaches the missing data point.

18. The apparatus according to claim 13, wherein the new window size (Hᵢ) is acquired by adding a previous window size (Hᵢ₋₁) to a value obtained by multiplying a weight constant (α) and a weight function β(Hᵢ₋₁).

19. The apparatus according to claim 13, wherein the new window size (Hᵢ) is acquired by multiplying a weight constant (α) and a weight function β(Hᵢ₋₁) associated with a previous window size (Hᵢ₋₁).

20. The apparatus according to claim 13, wherein the new window size is established according to a data download speed at which data is downloaded in the local storage.

21. The apparatus according to claim 13, wherein the new window size is established according to a buffer size of a playback system.

22. The apparatus according to claim 13, wherein in case that a data download time for downloading data according to the window size is longer than a maximum allowable delay time, the controller terminates the data reproduction.

23. The apparatus according to claim 22, wherein the maximum allowable delay time is determined by a playback system.
